(19) United States
(12) Patent Application Publication
(10) Pub. No.: US 2026/0311291 A1
(43) Pub. Date: Oct. 8, 2026

(54) IMAGE RECONSTRUCTION METHOD AND DEVICE, MEDIUM, AND PRODUCT

(71) Applicant: THE HONG KONG UNIVERSITY OF SCIENCE AND TECHNOLOGY (GUANGZHOU), Guangzhou (CN)

(72) Inventors: Hui Xiong, Guangzhou (CN); Yunfan Lu, Guangzhou (CN); Yijie Xu, Guangzhou (CN); Wenzong Ma, Guangzhou (CN); Weiyu Guo, Guangzhou (CN)

(21) Appl. No.: 19/466,294

(22) Filed: Jan. 31, 2026

Related U.S. Application Data
(63) Continuation-in-part of application No. PCT/CN2025/098685, filed on May 30, 2025.

(30) Foreign Application Priority Data
May 30, 2024 (CN) 202410692332.4

(51) Int. Cl. G06T 3/4046; G06N 3/0455; G06N 3/08

(52) U.S. Cl. CPC G06T 3/4046; G06N 3/0455; G06N 3/08

(57) ABSTRACT

Provided are an image reconstruction method and device, a medium, and a product. In the image reconstruction method, Swin Transformer modules in an encoding module are connected through a patch merging layer; and Swin Transformer modules in a decoding module are connected through a patch expanding layer. The encoding module and the decoding module are structurally symmetrical. Finally, an upsampled feature map is input into a reconstruction module for transformation to obtain an RGB image. A network is constructed based on a U-Net architecture, which can restore a corresponding high-resolution RGB image from a feature map. During demosaicing, missing value filling and defective pixel correction can be performed on a RAW image captured by an event camera, to obtain a high-quality RGB image. Swin Transformer is used as a feature extractor, which can effectively capture long-range dependencies and maintain consistency between local and global information.

### CROSS REFERENCE TO RELATED APPLICATION

This application is a continuation-in-part of International Patent Application No. PCT/CN2025/098685, filed on May 30, 2025. This application claims priority to Chinese Patent Application No. 202410692332.4, filed with the China National Intellectual Property Administration (CNIPA) on May 30, 2024 and entitled “IMAGE RECONSTRUCTION METHOD AND APPARATUS, DEVICE, MEDIUM, AND PRODUCT”, all of which are incorporated herein by reference in their entireties.

### TECHNICAL FIELD

This application belongs to image processing technologies, and in particular, relates to an image reconstruction method and device, a medium, and a product.

### BACKGROUND

A RAW image is usually sampled through a Bayer pattern. Specifically, red, green, and blue color channels are sampled in different arrangements to form a mosaic pattern. Reconstructing the RAW image into a color image (for example, an RGB image) requires demosaicing. In a demosaicing process, red, green, and blue values of each pixel are calculated based on the Bayer pattern and information about adjacent pixels, to generate a full-color image. After a regular camera captures a RAW image, only demosaicing needs to be considered in a process of converting the RAW image into a color image (for example, an RGB image).

However, due to a sensor design limitation of an event camera, when the event camera captures a RAW image, some values in red and blue information in a RAW domain are missing, and some random defective pixels also appear. A traditional solution fails to fill in the missing values and correct the defective pixels, resulting in low quality of a generated color image (for example, RGB image).

### SUMMARY

The embodiments of this application provide an image reconstruction method and device, a medium, and a product, which can fill in missing values and correct defective pixels when reconstructing a RAW image into a color image (for example, an RGB image), to generate a high-quality color image (for example, RGB image).

According to an aspect, an embodiment of this application provides an image reconstruction method, including:

inputting a RAW image captured by an event camera into a target image reconstruction model to obtain a color image, where the target image reconstruction model includes an encoding module, a decoding module, and a reconstruction module that are sequentially connected.

The inputting a RAW image captured by an event camera into a target image reconstruction model to obtain a color image includes:
inputting the RAW image into the encoding module to obtain a downsampled feature map, where the encoding module includes a plurality of Swin Transformer modules connected in series, and the Swin Transformer modules in the encoding module are connected through a patch merging layer;
inputting the downsampled feature map into the decoding module to obtain an upsampled feature map, where the decoding module includes a same quantity of Swin Transformer modules as the encoding module, and the Swin Transformer modules in the decoding module are connected through a patch expanding layer; and the encoding module and the decoding module are structurally symmetrical; and
inputting the upsampled feature map into the reconstruction module for reconstruction to obtain the color image.

In a possible implementation, the Swin Transformer modules in both the encoding module and the decoding module each include a layer normalization (LN) layer, a window-based multi-head self-attention (W-MSA) module, and a multilayer perceptron (MLP) layer.

In a possible implementation, after the inputting the upsampled feature map into the reconstruction module for reconstruction to obtain the color image, the method further includes:
obtaining a quality metric of the color image, where the quality metric includes at least one of a peak signal-to-noise ratio or a structural similarity index; and
in a case that the quality metric does not satisfy a first preset condition, adjusting the target image reconstruction model based on a standard quality metric.

In a possible implementation, before the inputting a RAW image captured by an event camera into a target image reconstruction model, the method further includes:
constructing an initial image reconstruction model;
inputting a RAW image training set with missing pixel values into the initial image reconstruction model for image reconstruction to obtain a predicted color image; and
training the initial image reconstruction model based on the predicted color image and an actual color image corresponding to the RAW image training set to obtain the target image reconstruction model.

In a possible implementation, before the inputting a RAW image training set with missing pixel values into the initial image reconstruction model for image reconstruction, the method further includes:

performing data augmentation on the RAW image training set, where the data augmentation includes any one or any combination of random cropping, rotation, and flipping.

The inputting a RAW image training set with missing pixel values into the initial image reconstruction model for image reconstruction includes:

inputting a data-augmented RAW image training set into the initial image reconstruction model for image reconstruction.

In a possible implementation, the training the initial image reconstruction model based on the predicted color image and an actual color image corresponding to the RAW image training set to obtain the target image reconstruction model includes:
determining a function value of a loss function based on the predicted color image and the actual color image; and
in a case that the function value does not satisfy a second preset condition, adjusting a parameter of the initial image reconstruction model, and returning to the step of inputting a RAW image training set with missing pixel values into the initial image reconstruction model for image reconstruction to obtain a predicted color image; or
in a case that the function value satisfies the second preset condition, using a current parameter of the initial image reconstruction model as a parameter of the target image reconstruction model, and obtaining the target image reconstruction model based on the parameter of the target image reconstruction model.

In a possible implementation, the loss function is as follows:

For an interval 0<d<a:

L_{pf}^{e}=(d/a)^{g}*b

For an interval a≤d≤1:

$${ℒ}_{𝓅𝒻}^{ℯ} = ( d - 1 ) ( 1 - b ) / ( 1 - a ) + 1$$

d is a difference between the predicted color image and the actual color image. a is a threshold parameter. b and g are scaling factors that control a gradient magnitude.

In a possible implementation, the loss function is as follows:

For an interval 0<d<a:

$${ℒ}_{𝓅𝒻}^{ℯ} = {( d / a )}^{g} * b$$

For an interval a≤d≤1:

$${ℒ}_{𝓅𝒻}^{ℯ} = {e}^{λ d} - λ d - 1$$

d is a difference between the predicted color image and the actual color image. a is a threshold parameter. b and g are scaling factors that control a gradient magnitude. λ is a hyperparameter.

According to another aspect, an embodiment of this application provides an image reconstruction device, including: a processor and a memory that stores a computer program instruction.

The processor, when executing the computer program instruction, implements the foregoing image reconstruction method.

According to still another aspect, an embodiment of this application provides a non-transitory computer-readable storage medium. The non-transitory computer-readable storage medium stores a computer program instruction. The computer program instruction, when executed by a processor, implements the foregoing image reconstruction method.

According to yet another aspect, an embodiment of this application provides a computer program product, including a non-transitory computer-readable storage medium that contains computer-readable program code. The computer-readable program code in the computer program product, when executed by a processor of an electronic device, enables the electronic device to perform the foregoing image reconstruction method.

In the image reconstruction method according to the embodiments of this application, after the event camera captures the RAW image, the RAW image is input into the target image reconstruction model to reconstruct the RAW image into the color image (for example, an RGB image). The target image reconstruction model includes the encoding module, the decoding module, and the reconstruction module that are sequentially connected. The RAW image is input into the encoding module to obtain the downsampled feature map. The encoding module includes the plurality of Swin Transformer modules connected in series. The Swin Transformer modules in the encoding module are connected through the patch merging layer. Then, the downsampled feature map is input into the decoding module to obtain the upsampled feature map. Finally, the upsampled feature map is input into the reconstruction module for transformation to obtain the color image (for example, RGB image). The decoding module includes the same quantity of Swin Transformer modules as the encoding module. The Swin Transformer modules in the decoding module are connected through the patch expanding layer. The encoding module and the decoding module are structurally symmetrical. The Swin Transformer modules in the encoding module are connected to the Swin Transformer modules in the decoding module through skip connections. In this solution, a network architecture combining Swin Transformer and U-Net is used. A network is constructed based on a U-Net architecture, which can restore a corresponding high-resolution color image (for example, RGB image) from a feature map. During demosaicing, missing value filling and defective pixel correction can be performed on the RAW image captured by the event camera, to obtain a high-quality color image (for example, RGB image). In addition, Swin Transformer is used as a feature extractor, which can effectively capture long-range dependencies and maintain consistency between local and global information.

### BRIEF DESCRIPTION OF THE DRAWINGS

To describe the technical solutions in the embodiments of this application more clearly, the following briefly describes the accompanying drawings required for the embodiments of this application. A person of ordinary skill in the art may still derive other drawings from these accompanying drawings without creative efforts.

FIG. 1 is a schematic flowchart of an image reconstruction method according to an embodiment of this application;

FIG. 2 is a schematic structural diagram of a target image reconstruction model according to an embodiment of this application;

FIG. 3 is a schematic diagram of a hardware structure of an image reconstruction device according to an embodiment of this application;

FIG. 4 is a schematic structural diagram of a target image reconstruction model according to an embodiment of this application;

FIG. 5 is a schematic structural diagram of a target image reconstruction model according to an embodiment of this application;

FIG. 6 is a structural block diagram of a Swin Transformer module according to an embodiment of this application; and

FIG. 7 is a schematic diagram of a connection relationship between an LN layer, a W-MSA module, and an MLP layer according to an embodiment of this application.

### DETAILED DESCRIPTION

Features of various aspects and exemplary embodiments of this application are described below in detail. To make the objectives, technical solutions, and advantages of this application clearer, this application is further described in detail below with reference to the accompanying drawings and embodiments. It should be understood that the embodiments described herein are merely used to explain this application, rather than to limit this application. A person skilled in the art can implement this application without some of these specific details. The following description of the embodiments is intended only to provide a better understanding of this application by illustrating examples of this application.

It should be noted that relational terms herein such as first and second are merely used to distinguish one entity or operation from another entity or operation without necessarily requiring or implying any actual such relationship or order between such entities or operations. In addition, terms “include”, “comprise”, or their any other variations are intended to cover a non-exclusive inclusion, such that a process, a method, an article, or a device that includes a series of elements not only includes those elements, but also includes other elements that are not explicitly listed, or also includes inherent elements of the process, the method, the article, or the device. Without more restrictions, the elements defined by the sentence “including . . . ” do not exclude the existence of other identical elements in a process, method, article, or device including the elements. The term “a plurality of” means two or more.

In the embodiments of this application, a color image may be, for example, an RGB image. The following describes a principle of this application by using an example in which a color image is an RGB image.

Most event camera-based imaging research focuses on enhancing images in an RGB domain by using event information, while neglecting a process from an image in a RAW domain (namely, a RAW image) to an image in the RGB domain (namely, an RGB image). Specifically, a camera captures light, with each pixel independently recording a single red, green, or blue signal, to generate an image in the RAW domain. Then, the image in the RAW domain needs for transformation to obtain an image in the RGB domain through a processing algorithm.

However, due to a sensor design limitation of an event camera, some values in red and blue information in the RAW domain are missing, and some random defective pixels also appear. Traditional demosaicing methods may be classified into two categories: model-based methods and machine learning-based methods. A traditional algorithm cannot resolve a problem of missing pixel values.

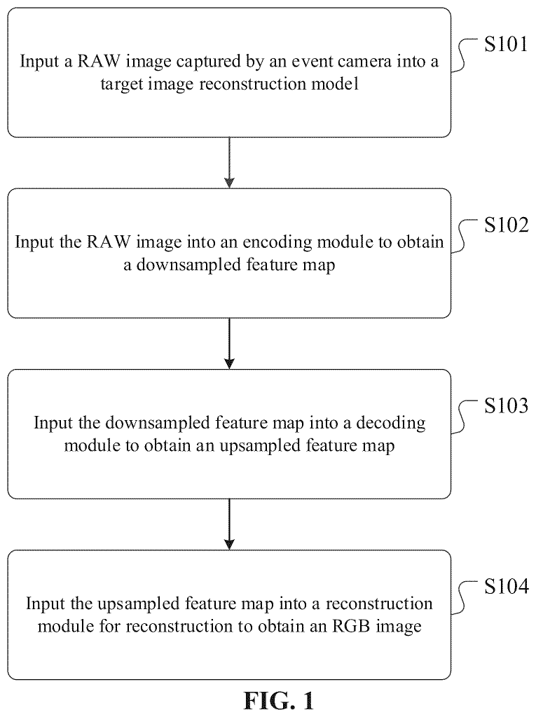

To estimate missing color information, a new demosaicing technology needs to be designed for an event camera to convert an incomplete single-channel RAW image into a complete RGB image. Specifically, the embodiments of this application provide an image reconstruction method and device, a medium, and a product. The following first describes the image reconstruction method provided in the embodiments of this application. FIG. 1 is a schematic flowchart of an image reconstruction method according to an embodiment of this application. As shown in FIG. 1, the method includes the following steps.
S101: Input a RAW image captured by an event camera into a target image reconstruction model.

The target image reconstruction model is obtained through pre-training based on a RAW image training set, and is used to reconstruct the RAW image into an RGB image. The target image reconstruction model includes an encoding module, a decoding module, and a reconstruction module that are sequentially connected.

Generally, a preprocessing module may further be included before the encoding module to convert a format of the input RAW image into a data format suitable for subsequent encoding and decoding stages. The preprocessing module aims to convert the data format of the input RAW image into the data format suitable for the subsequent encoding and decoding stages while reducing computational complexity.

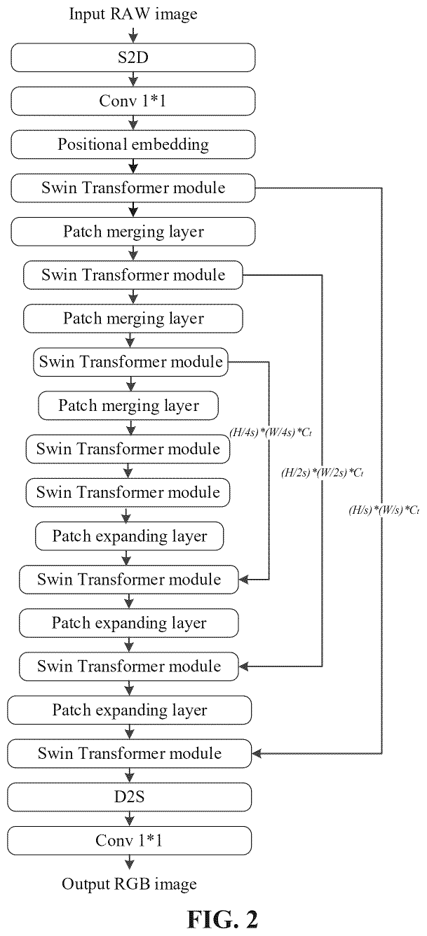

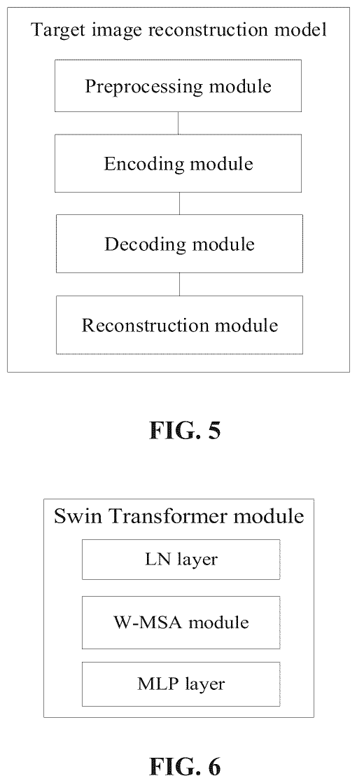

FIG. 5 is a schematic structural diagram of a target image reconstruction model according to an embodiment of this application. As shown in FIG. 5, the target image reconstruction model includes a preprocessing module, an encoding module, a decoding module, and a reconstruction module that are sequentially connected. As shown in FIG. 2, the preprocessing module first performs a space-to-depth (S2D) operation. Given an input RAW image I_{RAW}∈R^{H×W×1}, where H represents a height and W represents a width, an S2D operation is first applied. With a factor of s, a spatial resolution is reduced to (H/s)×(W/s), and a channel dimension is increased to s². This operation can effectively reduce complexity of the model because a computational cost scales linearly with a quantity of channels and quadratically with the spatial resolution. Then, a 1×1 convolution may be used to project a high-dimensional tensor s² onto a low-dimensional space with C channels, to obtain a latent feature F₀∈R^{(H/s)×(W/s)×C} of the image. R represents a set. To incorporate positional information, learnable positional information Eₚₒₛ∈R^{(H/s)×(W/s)×C} is further added:

$${E}_{p o s} ( 2 i ) = sin ( p / 1000 {0}^{2 i / C} )$$

$${E}_{p o s} ( 2 i + 1 ) = cos ( p / 1000 {0}^{2 i / C} )$$

p represents a position. i represents a dimension. A preprocessed feature may be obtained as follows: F₀′=F₀+Eₚₒₛ.
S102: Input the RAW image into the encoding module to obtain a downsampled feature map.

The encoding module includes a plurality of Swin Transformer modules (encoder blocks) connected in series. The Swin Transformer modules in the encoding module are connected through a patch merging layer. After the RAW image is input into the encoding module, the downsampled feature map is obtained through the Swin Transformer modules and patch merging layers that are alternately connected in the encoding module. The patch merging layer reduces a resolution of the image. The Swin Transformer module implements feature transformation.

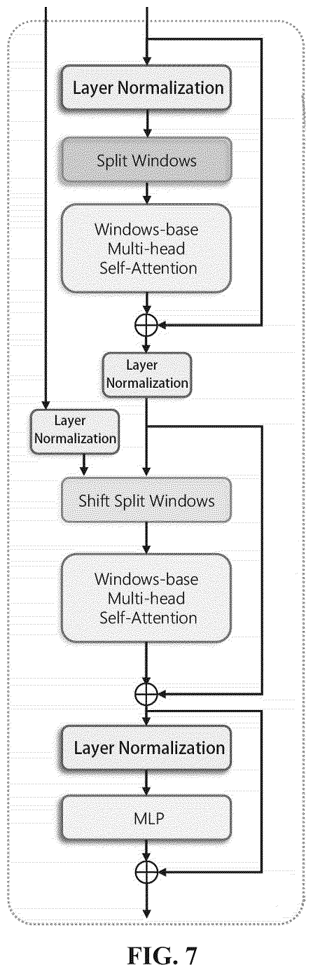

The encoding module aims to extract multi-scale features and capture long-range dependencies (namely, long-distance dependencies). In this application, a U-Net-like architecture is used with Swin Transformer as its core. The encoding module includes N stages. Each stage contains one Swin Transformer block (namely, Swin Transformer module) followed by one patch merging layer. As shown in FIG. 6 and FIG. 7, the Swin Transformer block includes an LN layer, a W-MSA module, and an MLP layer.

The W-MSA module allows the model to capture multi-scale features and structural details at different granularities. The Swin Transformer modules in the encoding module alternately use a shifted window mechanism to facilitate cross-window interaction and enhance the model's representation capability. Following the Swin Transformer block, one patch merging layer is applied to generate the downsampled feature map and increase the channel dimension. This multi-scale architecture enables the model to process information at a plurality of scales while gradually reducing the spatial resolution. Each downsampling operation reduces computational complexity by a factor (which may be 4) while increasing a receptive field by the factor, enabling the model to capture global information more effectively.
S103: Input the downsampled feature map into the decoding module to obtain an upsampled feature map.

The decoding module includes a same quantity of Swin Transformer modules (decoder blocks) as the encoding module. The Swin Transformer modules in the decoding module are connected through a patch expanding layer. The encoding module and the decoding module are structurally symmetrical. The resolution is first reduced through the patch merging layer in the encoding module, and then increased through the patch expanding layer in the decoding module. The upsampled feature map is obtained through a symmetrical structure.

Specifically, the decoding module aims to gradually generate the upsampled feature map and restore a spatial resolution of an output image. It employs a structure similar and symmetrical to that of the encoding module and includes N stages. Each decoding stage contains one Swin Transformer module followed by one patch expanding layer.

The Swin Transformer module in the decoding module also includes an LN layer, a W-MSA module, and an MLP layer. The W-MSA module herein operates similarly to that in the encoder block, and captures local dependencies within a window. Following each Swin Transformer module in the decoding module, one patch expanding layer is applied to increase the spatial resolution and reduce the channel dimension. In addition, a skip connection is introduced between corresponding encoder and decoder stages to facilitate information flow and detail recovery. The multi-scale architecture of the decoding module enables the model to gradually improve quality of the reconstructed image while combining features at different scales, to improve demosaicing performance.
S104: Input the upsampled feature map into the reconstruction module for reconstruction to obtain an RGB image.

The upsampled feature map is input into the reconstruction module. A goal of the reconstruction module is to generate and output a final RGB image based on the upsampled feature map.

To achieve this goal, a depth-to-space (D2S) operation may be first applied. This operation precisely reverses the S2D operation applied in the foregoing preprocessing module. This step is crucial for maintaining image quality and reducing distortion introduced during preprocessing. The D2S operation rearranges features, increases the spatial resolution by a factor of s, and restores original spatial dimensions of the input image. Finally, a 1×1 convolution may be used to map a high-dimensional feature to an expected output space, to generate an RGB image with a shape of H×W×3.

To resolve a demosaicing problem for signals in a RAW domain generated by an event camera, a neural network architecture that combines advantages of Swin Transformer and U-Net is designed in this application. Data preprocessing is first performed: Raw data is obtained from the event camera, to obtain images in a RAW format (namely, RAW images). Data in the RAW format (namely, the RAW images) is packaged in batches. An image data format and length are unified for subsequent training.

A network is specifically designed with Swin Transformer as a feature extractor, which can effectively capture long-range dependencies and maintain consistency between local and global information. The network is constructed based on a U-Net architecture, which can restore a corresponding high-resolution RGB image from a feature map.

During training, a RAW image with missing pixel values is used as input, whereas an actual RGB image serves as target output. A loss function is designed to train the network by using a difference between a reconstructed RGB image and the actual RGB image, to improve performance of the network. During training, appropriate data augmentation technologies, such as random cropping, rotation, and flipping, may further be used to enhance a generalization capability of the network.

Finally, a trained model may further be tested and evaluated. Demosaicing is performed on a new RAW image through the trained model, and a result is compared with an actual RGB image. Herein, standard image quality metrics, such as a peak signal-to-noise ratio and a structural similarity index, may be used to evaluate quality of a generated RGB image.

In this application, to resolve the demosaicing problem for signals in the RAW domain generated by an event camera, advantages of the Swin Transformer module and the U-Net architecture are leveraged to reconstruct a high-quality RGB image by using a RAW image with missing pixel values as input. In addition, a special loss function is designed for a region rich in high-frequency details, edges, and textures, to improve network performance.

In the image reconstruction method according to the embodiments of this application, after the event camera captures the RAW image, the RAW image is input into the target image reconstruction model to reconstruct the RAW image into the RGB image. The target image reconstruction model includes the encoding module, the decoding module, and the reconstruction module that are sequentially connected, as shown in FIG. 4. The RAW image is input into the encoding module to obtain the downsampled feature map. The encoding module includes the plurality of Swin Transformer modules connected in series. The Swin Transformer modules in the encoding module are connected through the patch merging layer. Then, the downsampled feature map is input into the decoding module to obtain the upsampled feature map. Finally, the upsampled feature map is input into the reconstruction module for transformation to obtain the RGB image. The decoding module includes the same quantity of Swin Transformer modules as the encoding module. The Swin Transformer modules in the decoding module are connected through the patch expanding layer. The encoding module and the decoding module are structurally symmetrical. The Swin Transformer modules in the encoding module are connected to the Swin Transformer modules in the decoding module through skip connections. In this solution, a network architecture combining Swin Transformer and U-Net is used. The network is constructed based on the U-Net architecture, which can restore the corresponding high-resolution RGB image from the feature map. During demosaicing, missing value filling and defective pixel correction can be performed on the RAW image captured by the event camera, to obtain a high-quality RGB image. In addition, Swin Transformer is used as a feature extractor, which can effectively capture long-range dependencies and maintain consistency between local and global information.

As shown in FIG. 6, as described in the foregoing embodiments, the Swin Transformer modules in both the encoding module and the decoding module each may include an LN layer, a W-MSA module, and an MLP layer. The LN layer normalizes all feature dimensions for each sample, unaffected by a batch size of samples. The W-MSA module allows the model to capture multi-scale features and structural details at different granularities. The MLP layer is a feedforward neural network, including a plurality of neurons. It establishes a mapping relationship between input and output by learning appropriate weights and biases.

Because performance of the target image reconstruction model obtained through training does not necessarily meet a requirement, image quality may be evaluated after the RGB image is generated.

Specifically, after the upsampled feature map is input into the reconstruction module for reconstruction to obtain the RGB image, the method further includes: obtaining a quality metric of the RGB image; and in a case that the quality metric does not satisfy a first preset condition, adjusting the target image reconstruction model based on a standard quality metric. The quality metric includes at least one of a peak signal-to-noise ratio or a structural similarity index. Specific content of the standard quality metric is not limited and is subject to an actual requirement.

In the embodiments of this application, the quality of the generated RGB image is evaluated, and the target image reconstruction model is adjusted if the quality is poor, to improve the quality of the generated RGB image.

In a construction and training process of the target image reconstruction model provided in the embodiments of this application, before the RAW image captured by the event camera is input into the target image reconstruction model, an initial image reconstruction model is constructed, and then a RAW image training set with missing pixel values is input into the initial image reconstruction model for image reconstruction to obtain a predicted RGB image. The initial image reconstruction model is trained based on the predicted RGB image and an actual RGB image corresponding to the RAW image training set to obtain the target image reconstruction model.

In the embodiments of this application, the model is trained through the predicted RGB image and the actual RGB image, to improve the performance of the model.

In practical application, when the model is trained through an original RAW image training set, an effect may not be satisfactory. To improve the performance of the model, data augmentation may be performed on the RAW image training set before the RAW image training set with missing pixel values is input into the initial image reconstruction model for image reconstruction. The data augmentation includes any one or any combination of random cropping, rotation, and flipping. Inputting the RAW image training set with missing pixel values into the initial image reconstruction model for image reconstruction includes: inputting a data-augmented RAW image training set into the initial image reconstruction model for image reconstruction.

A data augmentation solution provided in the embodiments of this application can enhance a generalization capability of the model.

The foregoing training process is not specifically limited. In practice, training may be completed by designing a loss function. Specifically, training the initial image reconstruction model based on the predicted RGB image and the actual RGB image corresponding to the RAW image training set to obtain the target image reconstruction model includes: determining a function value of a loss function based on the predicted RGB image and the actual RGB image; and in a case that the function value does not satisfy a second preset condition, adjusting a parameter of the initial image reconstruction model, and returning to the step of inputting the RAW image training set with missing pixel values into the initial image reconstruction model for image reconstruction to obtain the predicted RGB image; or in a case that the function value satisfies the second preset condition, using a current parameter of the initial image reconstruction model as a parameter of the target image reconstruction model, and obtaining the target image reconstruction model based on the parameter of the target image reconstruction model.

The initial image reconstruction model is continuously trained through the loss function designed in this application, to efficiently optimize the model and finally obtain the target image reconstruction model meeting the requirement.

A special loss function is designed in the embodiments of this application. In a demosaicing task, a region rich in high-frequency details, edges, and textures is more important and deserves more attention than a region that is easy to recover during training. Therefore, in this solution, a pixel-focus loss function is designed and used during network training, to improve network performance.

Herein, two loss functions are provided as examples to better capture edge-related differences. Certainly, another loss function may alternatively be used in specific application.

One of the loss functions is as follows:

For an interval 0<d<a:

$${ℒ}_{𝓅𝒻}^{ℯ} = {( d / a )}^{g} * b$$

For an interval a≤d≤1:

$${ℒ}_{𝓅𝒻}^{ℯ} = ( d - 1 ) ( 1 - b ) / ( 1 - a ) + 1$$

d is a difference between the predicted RGB image and the actual RGB image. a is a threshold parameter. b and g are scaling factors that control a gradient magnitude.

The other loss function is as follows:

For an interval 0<d<a:

$${ℒ}_{𝓅𝒻}^{ℯ} = {( d / a )}^{g} * b$$

For an interval a≤d≤1:

$${ℒ}_{𝓅𝒻}^{ℯ} = {e}^{λ d} - λ d - 1$$

d is a difference between the predicted RGB image and the actual RGB image. a is a threshold parameter. b and g are scaling factors that control a gradient magnitude. λ is a hyperparameter.

Both loss functions can enhance the model's ability to capture edge details, and improve demosaicing performance by emphasizing gradients for edge-related differences.

In practical application, for example, the image reconstruction method provided in the embodiments of this application may be applied to a vehicle driving scenario. Specifically, during driving of a vehicle, a RAW image captured by an event camera is input into the target image reconstruction model to obtain an RGB image. The vehicle recognizes an obstacle based on the RGB image, and outputs an obstacle recognition result to warn a driver to steer clear or stop. Alternatively, the vehicle may be controlled to stop based on the obstacle recognition result. Through the image reconstruction method provided in the embodiments of this application, a high-quality RGB image can be obtained during the driving of the vehicle. This can improve accuracy of recognizing a road obstacle, to effectively improve driving safety.

In the embodiments of this application, the preprocessing module, the encoding module, the decoding module, the reconstruction module, the Swin Transformer module, the LN layer, the W-MSA module, the MLP layer, the patch merging layer, and the patch expanding layer each may be one or more processors, controllers, or chips that each have a communication interface and can implement a communication protocol, and may further include a memory, a related interface, a system transmission bus, and the like if necessary. The processor, controller, or chip executes program-related code to implement a corresponding function. In an alternative solution, the preprocessing module, the encoding module, the decoding module, the reconstruction module, the Swin Transformer module, the LN layer, the W-MSA module, the MLP layer, the patch merging layer, and the patch expanding layer share an integrated chip or share devices such as a processor, a controller, and a memory. The shared processor, controller, or chip executes program-related code to implement a corresponding function.

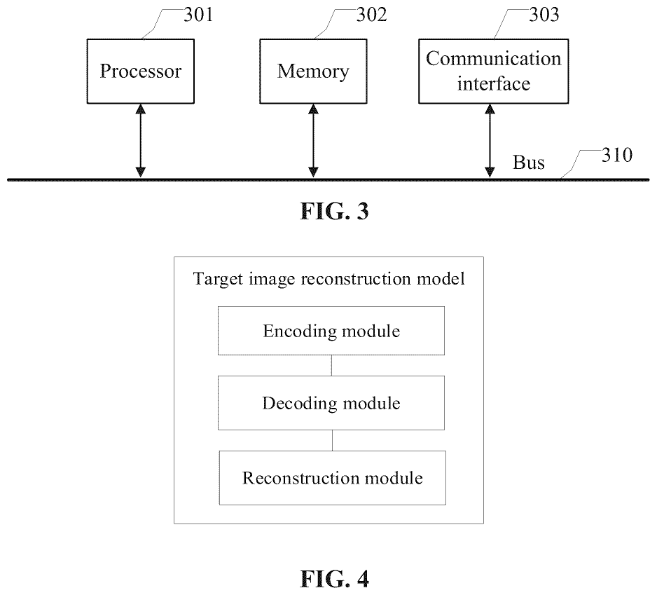

FIG. 3 is a schematic diagram of a hardware structure of an image reconstruction device according to an embodiment of this application. As shown in FIG. 3, the image reconstruction device may include a processor 301 and a memory 302 that stores a computer program instruction.

Specifically, the processor 301 may include a central processing unit (CPU) or an Application Specific Integrated Circuit (ASIC), or may be configured as one or more integrated circuits for implementing the embodiments of this application.

The memory 302 may include a mass memory for data or instructions. By way of example but not limitation, the memory 302 may include a hard disk drive (HDD), a floppy disk drive, a flash memory, an optical disk, a magnetic disk, a magnetic tape, or a universal serial bus (USB) drive, or a combination of two or more of these. If appropriate, the memory 302 may include a removable or non-removable (or fixed) medium. If appropriate, the memory 302 may be inside or outside of the image reconstruction device. In a specific embodiment, the memory 302 is a nonvolatile solid-state memory.

The memory 302 may include a read-only memory (ROM), a random access memory (RAM), a disk storage media device, an optical storage media device, a flash memory device, or an electrical, optical, or another physical/tangible memory storage device. Thus, typically, the memory includes one or more tangible (non-transitory) computer-readable storage media (for example, a memory device) encoded with software that includes computer-executable instructions. When the software is executed (for example, by one or more processors), the operations described with reference to the method according to an aspect of the present disclosure may be performed.

The processor 301 reads and executes computer program instructions stored in the memory 302, to implement the image reconstruction method according to any of the embodiments.

In an example, the image reconstruction device may further include a communication interface 303 and a bus 310. The processor 301, the memory 302, and the communication interface 303 are connected through the bus 310 to complete mutual communication.

The communication interface 303 is mainly configured to implement the communication between the modules, devices, units, and/or equipment in the embodiments of this application.

The bus 310 includes hardware, software, or both, to couple the components of the image reconstruction device to each other. By way of example but not limitation, the bus may include an accelerated graphics port (AGP) or another graphics bus, an extended industry standard architecture (EISA) bus, a front-side bus (FSB), a hypertransport (HT) interconnect, an industry standard architecture (ISA) bus, an InfiniBand interconnect, a low pin count (LPC) bus, a memory bus, a microchannel architecture (MCA) bus, a peripheral component interconnect (PCI) bus, a PCI-Express (PCI-X) bus, a Serial Advanced Technology Attachment (SATA) bus, a Video Electronics Standards Association local bus (VLB), or another suitable bus or a combination of two or more of these. If appropriate, the bus 310 may include one or more buses. Although specific buses are described and illustrated in the embodiments of this application, any suitable bus or interconnect may be used in this application.

In addition, an embodiment of this application may provide a non-transitory computer-readable storage medium to implement the image reconstruction method in the foregoing embodiments. The non-transitory computer-readable storage medium stores computer program instructions. When the computer program instructions are executed by a processor, any image reconstruction method in the foregoing embodiments is implemented.

The embodiments of the present disclosure further provide a computer program product. The computer program product includes a non-transitory computer-readable storage medium containing computer-readable program code. When executed by a processor of an electronic device, the computer-readable program code in the computer program product causes the electronic device to perform any of the image reconstruction methods described in the aforementioned embodiments.

It is to be clear that this application is not limited to the particular configuration and processing described above and illustrated in the accompanying drawings. A detailed description of the known method is omitted herein for the sake of brevity. In the above embodiments, several specific steps are described and illustrated as examples. However, the method of this application is not limited to the specific steps described and illustrated, and a person skilled in the art may make various changes, modifications and additions, or change the step sequence based on the spirit of this application.

The functional blocks shown in the structural block diagrams described above may be implemented as hardware, software, firmware, or a combination thereof. When implemented in hardware, the functional block may be, for example, an electronic circuit, an ASIC, appropriate firmware, a plug-in, a function card, or the like. When implemented in software, the elements of this application are programs or code segments that are used to perform the required task. The program or code segment may be stored in a machine-readable medium or transmitted on a transmission medium or communication link via a data signal carried in a carrier wave. A “machine-readable medium” may include any medium capable of storing or transmitting information. Examples of the machine-readable medium include an electronic circuit, a semiconductor memory device, a ROM, a flash memory, an erasable ROM (EROM), a floppy disk, a CD-ROM, an optical disk, a hard disk, a fiber optic medium, a radio frequency (RF) link, and the like. The code segment may be downloaded via computer networks such as the Internet or Intranets.

It is also noted that the exemplary embodiments mentioned in this application describe some methods or systems based on a series of steps or devices. However, this application is not limited to the above step sequence, that is, the steps may be performed in the sequence in the embodiments or in a sequence different from the sequence in the embodiments, or several steps may be performed simultaneously.

Various aspects of the present disclosure are described with reference to flowcharts and/or block diagrams of the image reconstruction method and device, storage media and computer program product according to embodiments of the present disclosure. It should be understood that each block of the flowcharts and/or block diagrams, and combinations of blocks in the flowcharts and/or block diagrams, can be implemented by the computer program instructions. The compute program instructions can be provided to a processor of a general-purpose computer, a dedicated computer, or other programmable data processing device, to produce a machine that makes the instruction when executed by the processor of the computer or other programmable data processing devices to implement the functions/actions specified in one or more blocks in the flowcharts and/or block diagrams. Such a processor may be, but is not limited to, a general purpose processor, an application specific processor, or a field programmable logic circuit. It should also be noted that each block in the flowcharts and/or block diagrams and combinations of the blocks in the flowcharts and/or block diagrams may be implemented by dedicated hardware for executing specified functions or operations, or may be implemented by a combination of dedicated hardware and computer instructions.

The foregoing descriptions are merely specific implementations of this application. A person skilled in the art can clearly understand that, for convenience and brevity of description, reference may be made to corresponding processes in the foregoing method embodiments for specific working processes of the foregoing systems, apparatuses, and units. Details are not described herein again. It should be understood that the protection scope of this application is not limited herein. Any equivalent modification or replacement readily figured out by a person skilled in the art within the technical scope disclosed in the present disclosure shall fall within the protection scope of the present disclosure.

1. An image reconstruction method, comprising:
inputting a RAW image captured by an event camera into a target image reconstruction model to obtain a color image, wherein the target image reconstruction model comprises an encoding module, a decoding module, and a reconstruction module that are sequentially connected; wherein
the inputting a RAW image captured by an event camera into a target image reconstruction model to obtain a color image comprises:
inputting the RAW image into the encoding module to obtain a downsampled feature map, wherein the encoding module comprises a plurality of Swin Transformer modules connected in series, and the Swin Transformer modules in the encoding module are connected through a patch merging layer;
inputting the downsampled feature map into the decoding module to obtain an upsampled feature map, wherein the decoding module comprises a same quantity of Swin Transformer modules as the encoding module, and the Swin Transformer modules in the decoding module are connected through a patch expanding layer; and the encoding module and the decoding module are structurally symmetrical, and the Swin Transformer modules in the encoding module are connected to the Swin Transformer modules in the decoding module through skip connections; and
inputting the upsampled feature map into the reconstruction module for reconstruction to obtain the color image.

2. The image reconstruction method according to claim 1, wherein the Swin Transformer modules in both the encoding module and the decoding module each comprise a layer normalization (LN) layer, a window-based multi-head self-attention (W-MSA) module, and a multilayer perceptron (MLP) layer.

3. The image reconstruction method according to claim 1, after the inputting the upsampled feature map into the reconstruction module for reconstruction to obtain the color image, further comprising:
obtaining a quality metric of the color image, wherein the quality metric comprises at least one of a peak signal-to-noise ratio or a structural similarity index; and
in a case that the quality metric does not satisfy a first preset condition, adjusting the target image reconstruction model based on a standard quality metric.

4. The image reconstruction method according to claim 1, before the inputting a RAW image captured by an event camera into a target image reconstruction model, further comprising:
constructing an initial image reconstruction model;
inputting a RAW image training set with missing pixel values into the initial image reconstruction model for image reconstruction to obtain a predicted color image; and
training the initial image reconstruction model based on the predicted color image and an actual color image corresponding to the RAW image training set to obtain the target image reconstruction model.

5. The image reconstruction method according to claim 2, before the inputting a RAW image captured by an event camera into a target image reconstruction model, further comprising:
constructing an initial image reconstruction model;
inputting a RAW image training set with missing pixel values into the initial image reconstruction model for image reconstruction to obtain a predicted color image; and
training the initial image reconstruction model based on the predicted color image and an actual color image corresponding to the RAW image training set to obtain the target image reconstruction model.

6. The image reconstruction method according to claim 3, before the inputting a RAW image captured by an event camera into a target image reconstruction model, further comprising:
constructing an initial image reconstruction model;
inputting a RAW image training set with missing pixel values into the initial image reconstruction model for image reconstruction to obtain a predicted color image; and
training the initial image reconstruction model based on the predicted color image and an actual color image corresponding to the RAW image training set to obtain the target image reconstruction model.

7. The image reconstruction method according to claim 4, before the inputting a RAW image training set with missing pixel values into the initial image reconstruction model for image reconstruction, further comprising:
performing data augmentation on the RAW image training set, wherein the data augmentation comprises any one or any combination of random cropping, rotation, and flipping; wherein
the inputting a RAW image training set with missing pixel values into the initial image reconstruction model for image reconstruction comprises:
inputting a data-augmented RAW image training set into the initial image reconstruction model for image reconstruction.

8. The image reconstruction method according to claim 5, before the inputting a RAW image training set with missing pixel values into the initial image reconstruction model for image reconstruction, further comprising:
performing data augmentation on the RAW image training set, wherein the data augmentation comprises any one or any combination of random cropping, rotation, and flipping; wherein
the inputting a RAW image training set with missing pixel values into the initial image reconstruction model for image reconstruction comprises:
inputting a data-augmented RAW image training set into the initial image reconstruction model for image reconstruction.

9. The image reconstruction method according to claim 6, before the inputting a RAW image training set with missing pixel values into the initial image reconstruction model for image reconstruction, further comprising:
performing data augmentation on the RAW image training set, wherein the data augmentation comprises any one or any combination of random cropping, rotation, and flipping; wherein
the inputting a RAW image training set with missing pixel values into the initial image reconstruction model for image reconstruction comprises:
inputting a data-augmented RAW image training set into the initial image reconstruction model for image reconstruction.

10. The image reconstruction method according to claim 4, wherein the training the initial image reconstruction model based on the predicted color image and an actual color image corresponding to the RAW image training set to obtain the target image reconstruction model comprises:
determining a function value of a loss function based on the predicted color image and the actual color image; and
in a case that the function value does not satisfy a second preset condition, adjusting a parameter of the initial image reconstruction model, and returning to the step of inputting a RAW image training set with missing pixel values into the initial image reconstruction model for image reconstruction to obtain a predicted color image; or
in a case that the function value satisfies the second preset condition, using a current parameter of the initial image reconstruction model as a parameter of the target image reconstruction model, and obtaining the target image reconstruction model based on the parameter of the target image reconstruction model.

11. The image reconstruction method according to claim 5, wherein the training the initial image reconstruction model based on the predicted color image and an actual color image corresponding to the RAW image training set to obtain the target image reconstruction model comprises:
determining a function value of a loss function based on the predicted color image and the actual color image; and
in a case that the function value does not satisfy a second preset condition, adjusting a parameter of the initial image reconstruction model, and returning to the step of inputting a RAW image training set with missing pixel values into the initial image reconstruction model for image reconstruction to obtain a predicted color image; or
in a case that the function value satisfies the second preset condition, using a current parameter of the initial image reconstruction model as a parameter of the target image reconstruction model, and obtaining the target image reconstruction model based on the parameter of the target image reconstruction model.

12. The image reconstruction method according to claim 6, wherein the training the initial image reconstruction model based on the predicted color image and an actual color image corresponding to the RAW image training set to obtain the target image reconstruction model comprises:
determining a function value of a loss function based on the predicted color image and the actual color image; and
in a case that the function value does not satisfy a second preset condition, adjusting a parameter of the initial image reconstruction model, and returning to the step of inputting a RAW image training set with missing pixel values into the initial image reconstruction model for image reconstruction to obtain a predicted color image; or
in a case that the function value satisfies the second preset condition, using a current parameter of the initial image reconstruction model as a parameter of the target image reconstruction model, and obtaining the target image reconstruction model based on the parameter of the target image reconstruction model.

13. The image reconstruction method according to claim 10, wherein the loss function is as follows:
for an interval 0<d<a:
$${ℒ}_{𝓅𝒻}^{ℯ} = {( d / a )}^{g} * b$$
for an interval a≤d≤1:
$${ℒ}_{𝓅𝒻}^{ℯ} = ( d - 1 ) ( 1 - b ) / ( 1 - a ) + 1$$
wherein d is a difference between the predicted color image and the actual color image, a is a threshold parameter, and b and g are scaling factors that control a gradient magnitude.

14. The image reconstruction method according to claim 11, wherein the loss function is as follows:
for an interval 0<d<a:
$${ℒ}_{𝓅𝒻}^{ℯ} = {( d / a )}^{g} * b$$
for an interval a≤d≤1:
$${ℒ}_{𝓅𝒻}^{ℯ} = ( d - 1 ) ( 1 - b ) / ( 1 - a ) + 1$$
wherein d is a difference between the predicted color image and the actual color image, a is a threshold parameter, and b and g are scaling factors that control a gradient magnitude.

15. The image reconstruction method according to claim 12, wherein the loss function is as follows:
for an interval 0<d<a:
$${ℒ}_{𝓅𝒻}^{ℯ} = {( d / a )}^{g} * b$$
for an interval a≤d≤1:
$${ℒ}_{𝓅𝒻}^{ℯ} = ( d - 1 ) ( 1 - b ) / ( 1 - a ) + 1$$
wherein d is a difference between the predicted color image and the actual color image, a is a threshold parameter, and b and g are scaling factors that control a gradient magnitude.

16. The image reconstruction method according to claim 10, wherein the loss function is as follows:
for an interval 0<d<a:
$${ℒ}_{𝓅𝒻}^{ℯ} = {( d / a )}^{g} * b$$
for an interval a≤d≤1:
$${ℒ}_{𝓅𝒻}^{ℯ} = {e}^{λ d} - λ d - 1$$
wherein d is a difference between the predicted color image and the actual color image, a is a threshold parameter, b and g are scaling factors that control a gradient magnitude, and λ is a hyperparameter.

17. The image reconstruction method according to claim 11, wherein the loss function is as follows:
for an interval 0<d<a:
$${ℒ}_{𝓅𝒻}^{ℯ} = {( d / a )}^{g} * b$$
for an interval a≤d≤1:
$${ℒ}_{𝓅𝒻}^{ℯ} = {e}^{λ d} - λ d - 1$$
wherein d is a difference between the predicted color image and the actual color image, a is a threshold parameter, b and g are scaling factors that control a gradient magnitude, and λ is a hyperparameter.

18. An image reconstruction device, comprising: a processor and a memory that stores a computer program instruction; wherein
the processor, when executing the computer program instruction, implements the image reconstruction method according to claim 1.

19. A non-transitory computer-readable storage medium, wherein the non-transitory computer-readable storage medium stores a computer program instruction, and the computer program instruction, when executed by a processor, implements the image reconstruction method according to claim 1.

20. A computer program product, comprising: a non-transitory computer-readable storage medium that contains computer-readable program code, wherein the computer-readable program code in the computer program product, when executed by a processor of an electronic device, enables the electronic device to perform the image reconstruction method according to claim 1.
